(19) United States
(12) Patent Application Publication
(10) Pub. No.: US 2020/0030944 A1
(43) Pub. Date: Jan. 30, 2020

(54) Tool Adapted to be Driven Rapidly

(71) Applicant: Hong Ann Tool Industries Co., Ltd., Taichung City (TW)

(72) Inventor: Cheng-Wei Su, Taichung City (TW)

(21) Appl. No.: 16/282,415

(22) Filed: Feb. 22, 2019

(30) Foreign Application Priority Data
Jul. 30, 2018 (TW) 107126259

(51) Int. Cl. B25B 7/02; B25B 13/08; B25B 13/14; B25B 7/10

(52) U.S. Cl. CPC B25B 7/02; B25B 7/10; B25B 13/14; B25B 13/08

(57) ABSTRACT

A tool adapted to be driven rapidly includes a driving portion which has a first jaw and a second jaw and an opening between the first and the second jaws configured to receive an object to be driven. The first and the second jaws have first and second engaging sides configured to grip the object to be driven. The opening has a closed end, an open end, and two opposite sides respectively delimited by the first and the second engaging sides. The first engaging side extends along a linear line. The second engaging side extends along a curved line. The closed end of the opening has a smaller width than the open end of the opening.

### BACKGROUND OF THE INVENTION

### 1. Field of the Invention

The present invention relates to a tool and, particularly, to a tool adapted to be driven rapidly.

### 2. Description of the Related Art

In order to allow a user to use an open end wrench without having to reposition the wrench on an object to be driven after each turn. TW Patent No. M483145 discloses a ratchet type open end wrench. The wrench has a body. The body has a grip and a head connected to the grip. The head has a first jaw and a second jaw for holding an object to be driven. The first jaw has a slot and a pawl is movably engaged in the slot. The pawl is urged by a spring. The pawl is not moved in the slot when the wrench turns the object. The pawl is, however, movable in the slot to a retracted position to allow the wrench to rotate relative to the object.

The wrench has a complicated structure. Thus, it is difficult to make the wrench, and it has a high cost. Further, the pawl is often stuck, especially after a long period of use.

The present invention is, therefore, intended to obviate or at least alleviate the problems encountered in the prior art.

### SUMMARY OF THE INVENTION

According to the present invention, a tool adapted to be driven rapidly includes a driving portion which has a first jaw and a second jaw configured to hold an object to be driven therebetween and an opening between the first and the second jaws configured to receive the object to be driven. The first and the second jaws have first and second engaging sides configured to grip the object to be driven. The opening has a closed end, an open end, and two opposite sides respectively delimited by the first and the second engaging sides. The first engaging side extends along a linear line. The second engaging side extends along a curved line. The closed end of the opening has a width smaller than a width of the open end of the opening.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the public generally, and especially the scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a perspective view of a tool adapted to be driven rapidly in accordance with a first embodiment of the present invention.

FIG. 2 is an enlarged, side view of a driving portion of the tool of FIG.

FIG. 3 shows the driving portion of the tool of FIG. 1 engaging with an object to be driven.

FIG. 4 shows the tool of FIG. 1 driving the object clockwise.

FIG. 5 shows the tool of FIG. 1 driving the object counterclockwise.

FIG. 6 is a perspective view of a tool adapted to be driven rapidly in accordance with a second embodiment of the present invention.

FIG. 7 is a cross-sectional view of the tool of FIG. 6.

FIG. 8 is a perspective view of a tool adapted to be driven rapidly in accordance with a third embodiment of the present invention.

FIG. 9 is a cross-sectional view of the tool of FIG. 8.

FIG. 10 is a perspective view of a tool adapted to be driven rapidly in accordance with a fourth embodiment of the present invention.

FIG. 11 is a cross-sectional view of the tool of FIG. 10.

FIG. 12 is a perspective view of a tool adapted to be driven rapidly in accordance with a fifth embodiment of the present invention.

FIG. 13 is an enlarged, side view of a driving portion of the tool of FIG. 12.

FIG. 14 is a perspective view of a tool adapted to be driven rapidly in accordance with a sixth embodiment of the present invention.

FIG. 15 is an enlarged, side view of a driving portion of the tool of FIG. 14.

### DETAILED DESCRIPTION OF THE INVENTION

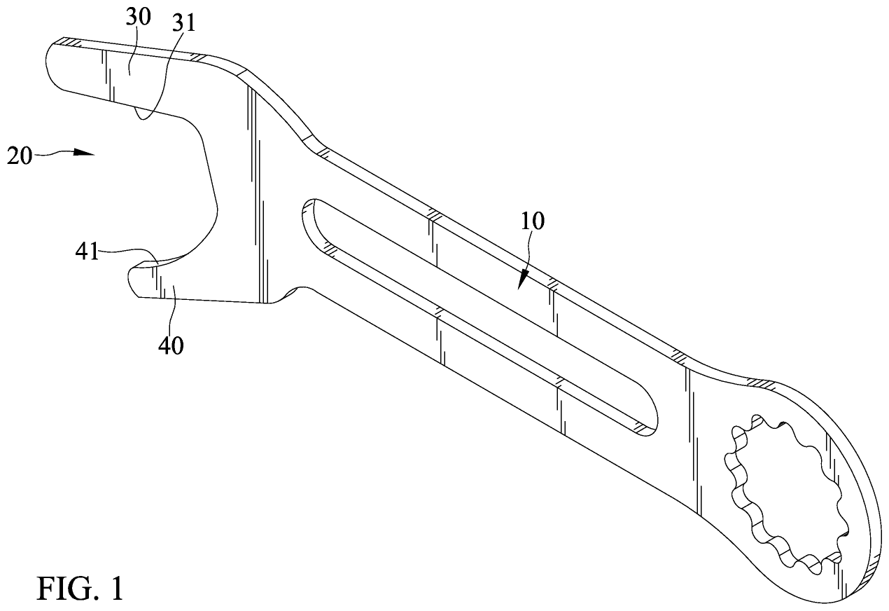

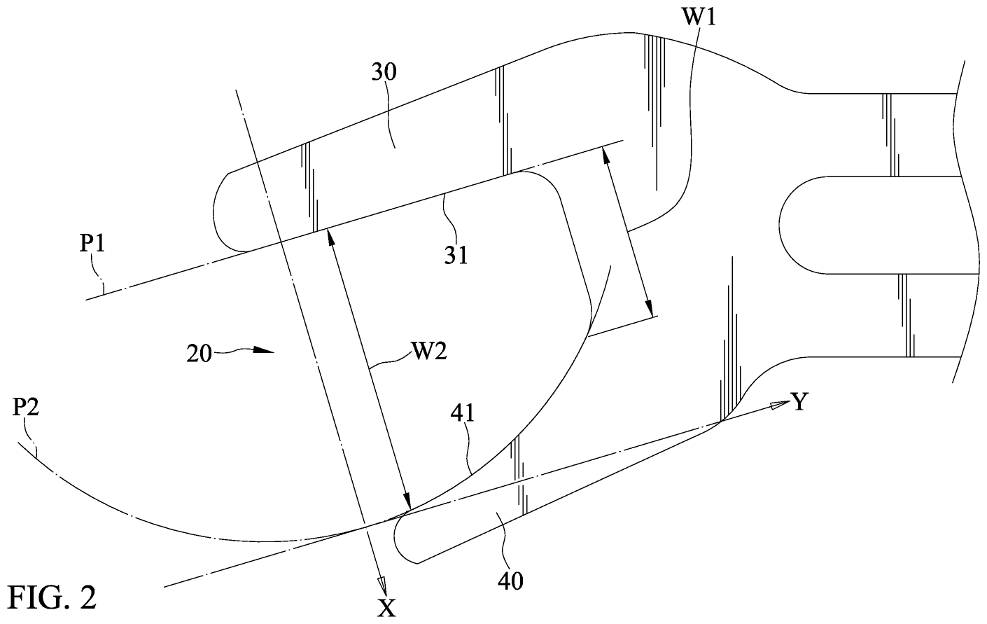

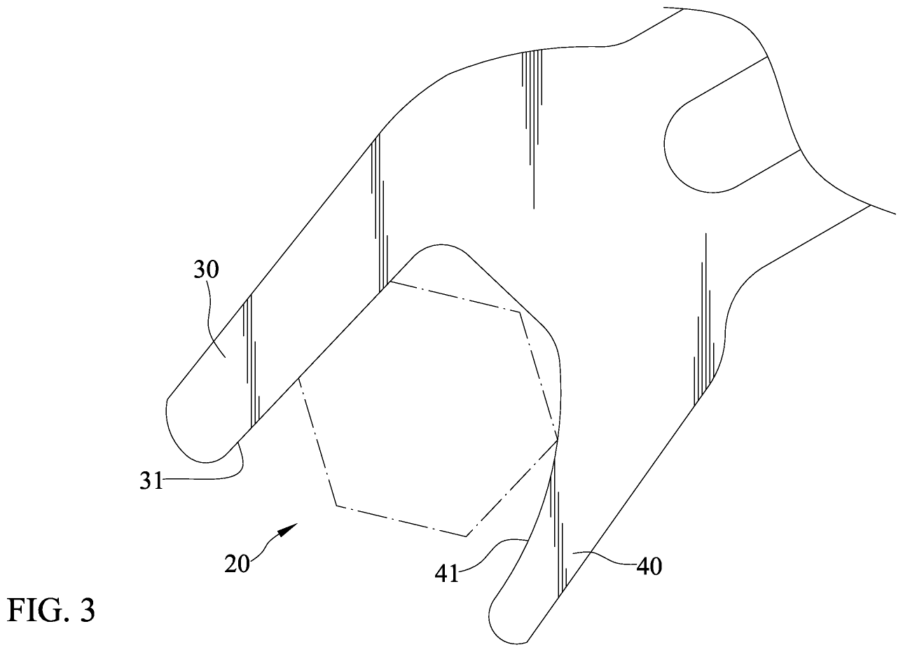

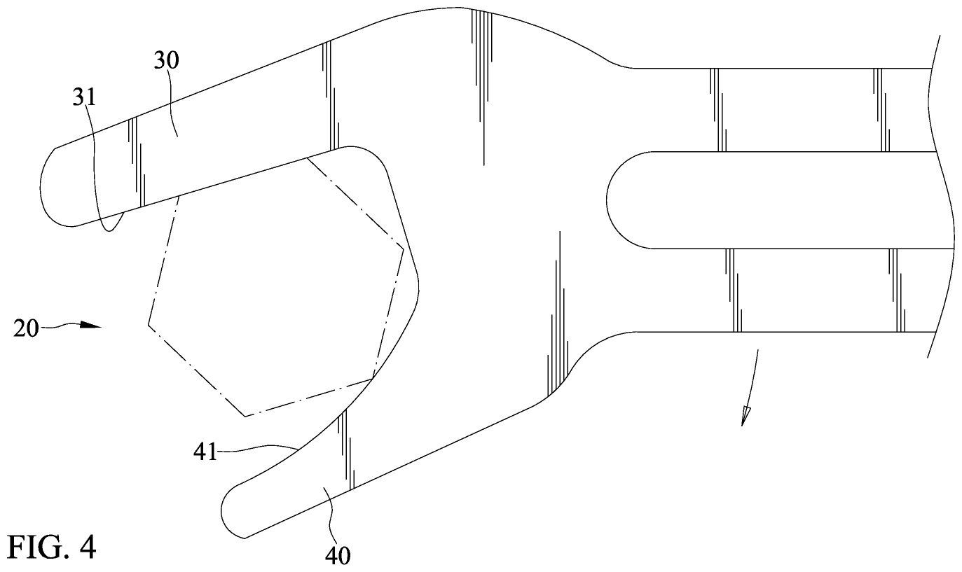

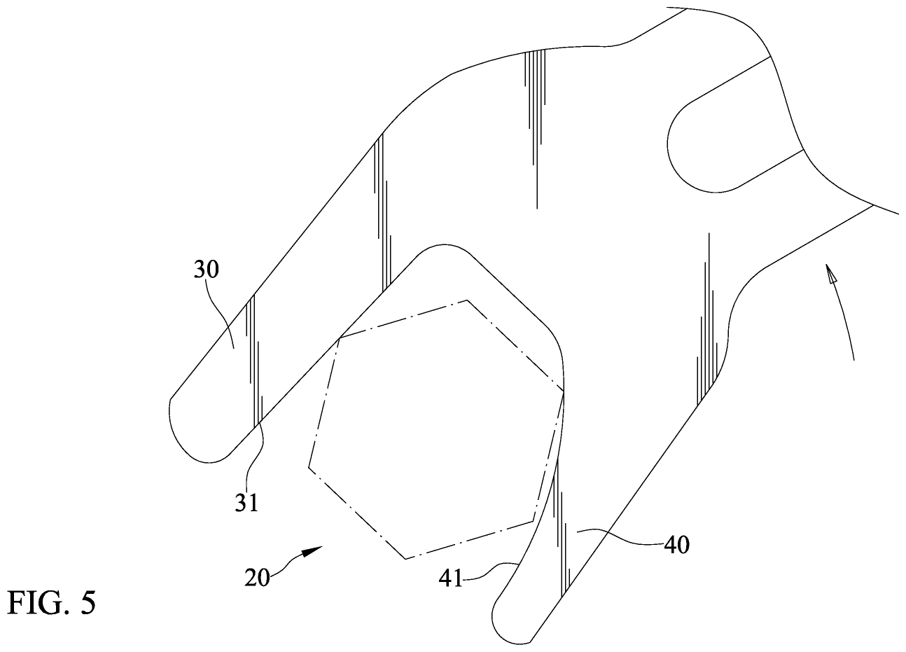

FIGS. 1 through 5 show a tool 10 adapted to be driven rapidly in accordance with a first embodiment of the present invention.

The tool 10 has a driving portion. The driving portion has a jaw 30 and a jaw 40 configured to hold an object to be driven therebetween. The driving portion has an opening 20 between the jaws 30 and 40 configured to receive the object to be driven.

The jaws 30 and 40 have engaging sides 31 and 41 configured to grip the object to be driven. The engaging sides 31 and 41 are formed in one piece. The opening 20 has a closed end, an open end, and two opposite sides respectively delimited by the engaging sides 31 and 41. The closed end of the opening 20 has a width smaller than a width of the open end of the opening 20. Each of the engaging sides 31 and 41 has a first end adjacent to the closed end of the opening 20 and a second end adjacent to the open end of the opening 20. The first ends of the engaging sides 31 and 41 are spaced at a first perpendicular distance measuring a width W1. The second ends of the engaging sides 31 and 41 are spaced at a perpendicular distance measuring a width W2. The width W1 is smaller than the width W2.

The engaging side 31 extends along a linear line P1. The engaging side 41 extends along a curved line P2. The engaging side 41 extends along a parabola. The parabola has an axis of symmetry X which is perpendicular to the engaging side 31. The parabola has a vertex on an arbitrary axis Y which is parallel to the engaging side 31. The parabola has an equation:

y²=−12x.

The tool 10 can be operated in a first direction to turn relative to the object and a second direction to drive the object. When the tool 10 is used to drive the object, the object is in static with respect to the engaging sides 31 and 41.

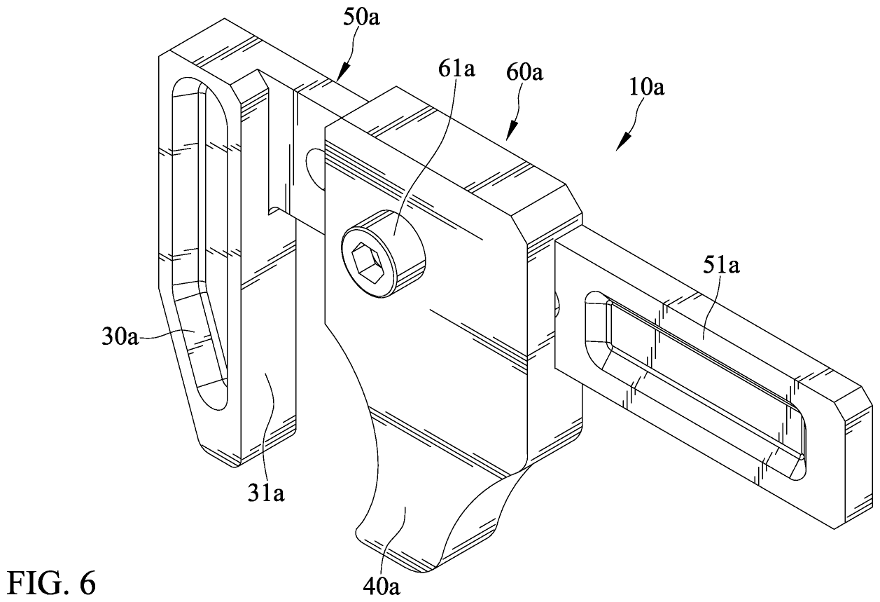

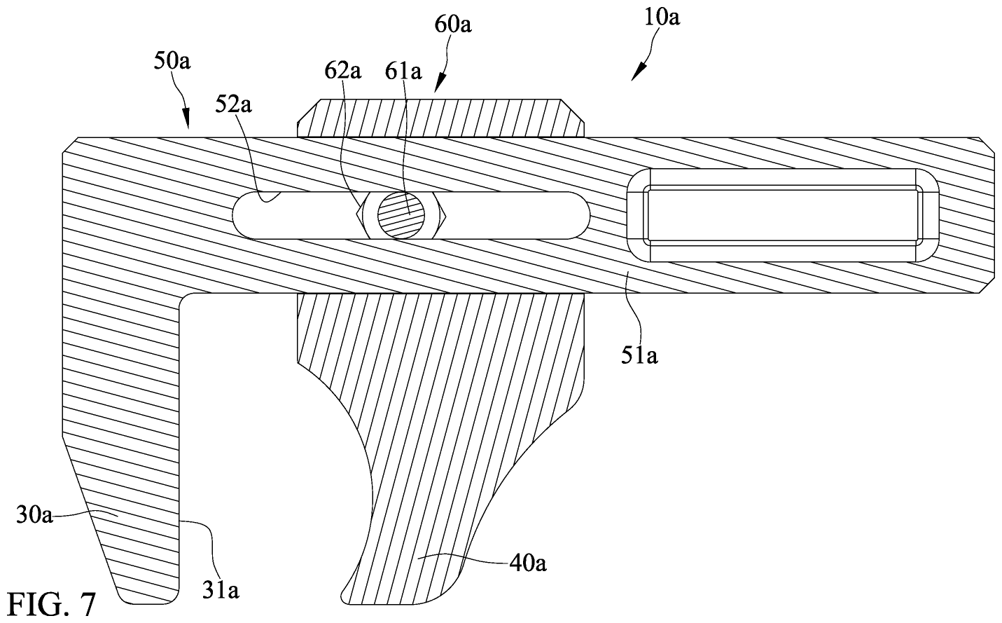

FIGS. 6 and 7 show a tool 10a in accordance with a second embodiment of the present invention, and the same numbers are used to correlate similar components of the first embodiment, but bearing a letter a. The tool 10a has a jaw 30a and a jaw 40a. An engaging side 31a extends linearly. An engaging side of the jaw 40a extends curvedly and along a parabola. The tool 10a differentiates from the tool 10 in that it has a body 50a and a body 60a movably coupled to the body 50a. The body 50a has the jaw 30a. The body 60a has the jaw 40a. The body 60a is slidably coupled to the body 50a such that the opening varies in size in response to sliding movement of the body 60a with respect to the body 50a. The body 50a has a shank 51a and the body 60a is slidably coupled to the shank 51a. The engaging side 31a of the jaw 30a has a longitudinal length transverse to a longitudinal length of the shank 51a. In this embodiment, the longitudinal length of the engaging side is substantially perpendicular to the longitudinal length of the shank 51a.

Further, the body 50a defines a groove 52a and the body 60a has a connecting portion 61a movably engaged in the groove 52a. The body 60a is operably movable between a first position in which the connecting portion 61a is disposed adjacent to a first end of the groove 52a and the jaws 30a and 40a are disposed adjacent to each other such that the opening has a first size, and a second position in which the connecting portion 61a is disposed adjacent to a second end of the groove 52a and the jaws 30a and 40a are disposed away from each other such that the opening has a second size which is greater than the first size. The connecting portion 61a is engaged with a fastener 62a. The connecting portion 61a is prevented from moving out of the groove 52a by the fastener 62a. The fastener 62a is disposed outside the groove 52a.

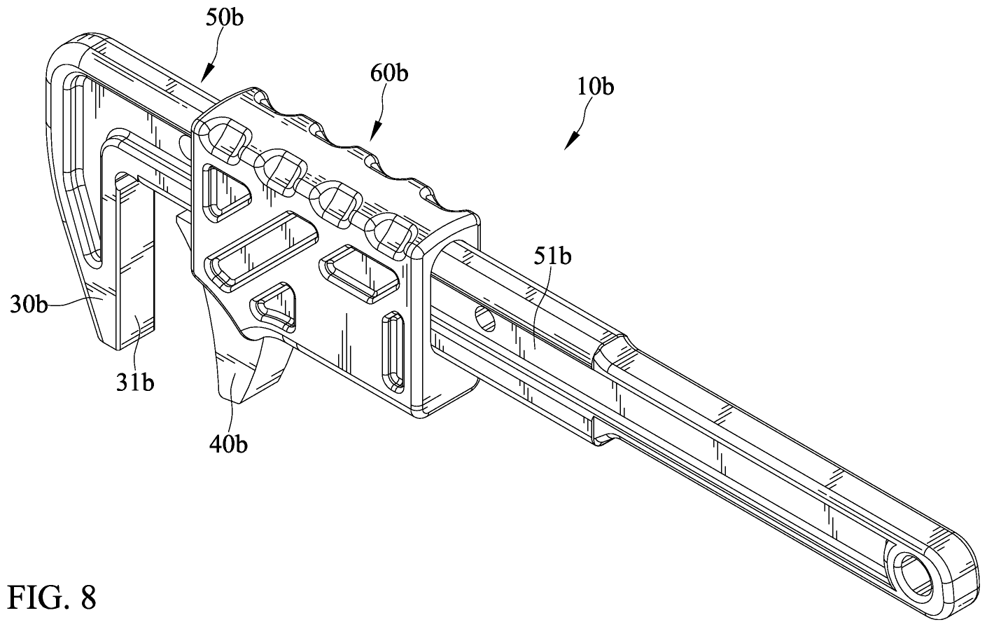

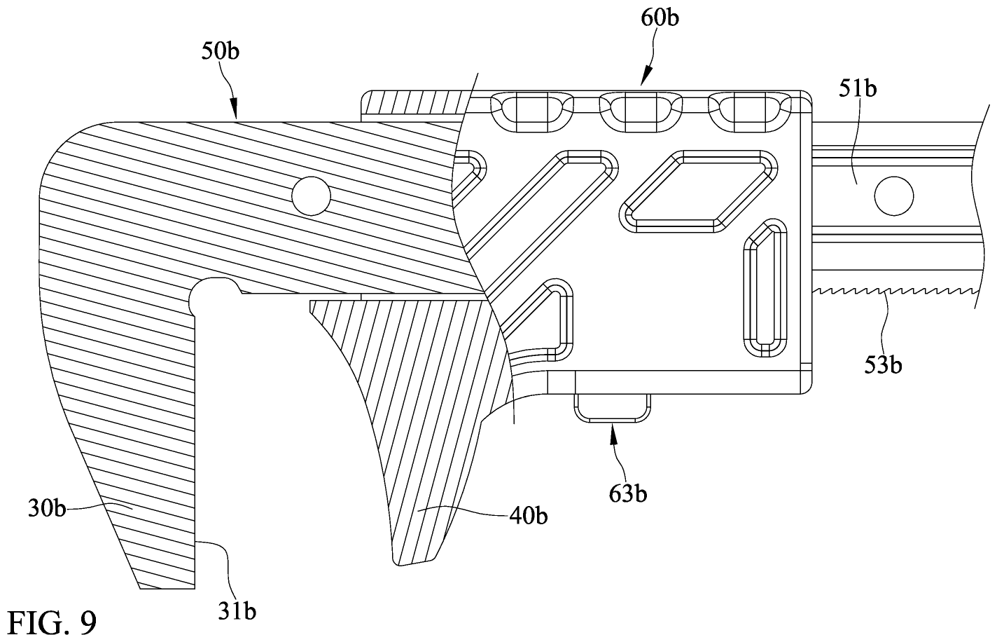

FIGS. 8 and 9 show a tool 10b in accordance with a third embodiment of the present invention, and the same numbers are used to correlate similar components of the first embodiment, but bearing a letter b. The tool 10b has a jaw 30b and a jaw 40b. An engaging side 31b extends linearly. An engaging side of the jaw 40b extends curvedly and along a parabola. The tool 10b differentiates from the tool 10 in that it has a body 50b and a body 60b movably coupled to the body 50b. The body 50b has the jaw 30b. The body 60b has the jaw 40b. The body 60b is slidably coupled to the body 50b such that the opening varies in size in response to sliding movement of the body 60b with respect to the body 50b. The body 50b has a shank 51b and the body 60b is slidably coupled to the shank 51b.

Further, the body 50b has a position retaining portion 53b and the body 60b includes a catch 63b coupled thereto movably engaged with the position retaining portion 53b. The catch 63b is operably movable between a first position engaging with the position retaining portion 53b such that the body 60b is unmovably fixed to the body 50b, and a second position disengaging form the position retaining portion 53b such that the body 60b is movably disposed on the body 50b. The position retaining portion 53b includes a plurality of teeth on which the catch 63b is adapted to engage.

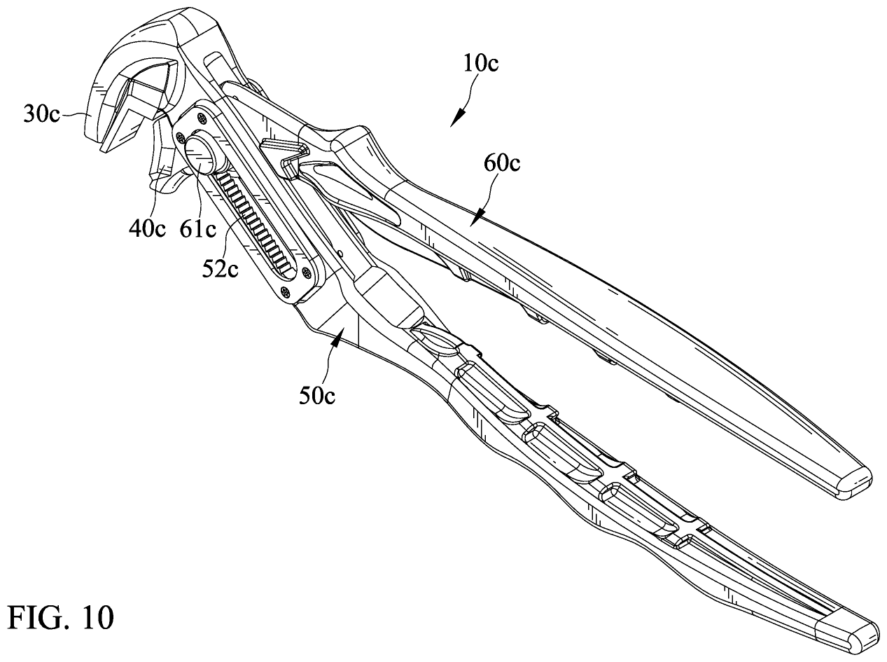

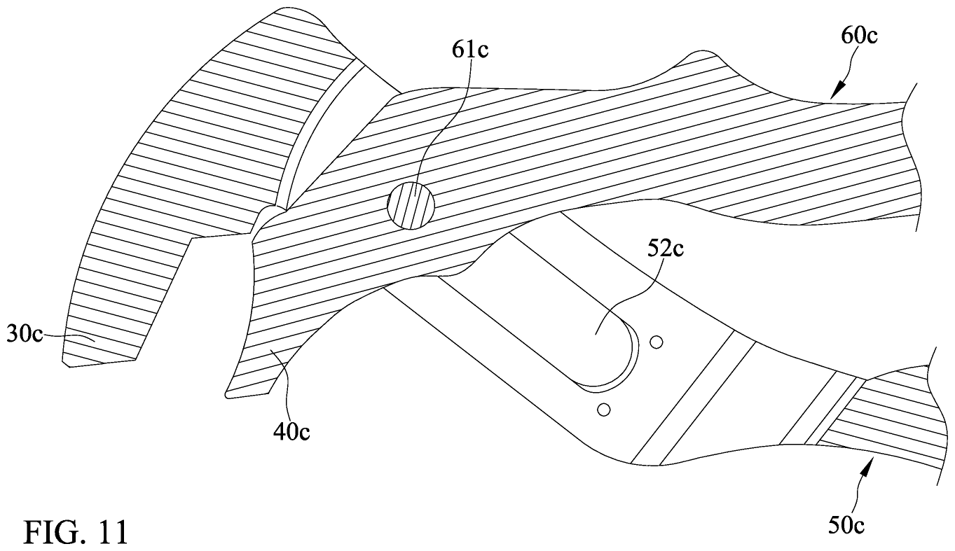

FIGS. 10 and 11 show a tool head in accordance with a fourth embodiment of the present invention, and the same numbers are used to correlate similar components of the first embodiment, but bearing a letter c. The tool 10c has a jaw 30c and a jaw 40c. An engaging side of the jaw 30 extends linearly. An engaging side of the jaw 40c extends curvedly and along a parabola. The tool 10c differentiates from the tool 10 in that it has a body 50c and a body 60c movably coupled to the body 50c. The body 50c has the jaw 30c. The body 60b has the jaw 40c. The body 60c is pivotally coupled to the first body 50c such that the opening varies in size in response to pivoting movement of the second body 60c with respect to the first body 50c.

Further, the body 50c defines a groove 52c and the body 60c has a connecting portion 61c movably engaged in the groove 52c. The second body 60c is operably movable between a first position in which the connecting portion 61c is disposed adjacent to a first end of the groove 52c and the jaws 30c and 40c are disposed adjacent to each other such that the opening has a first size, and a second position in which the connecting portion 61c is disposed adjacent to a second end of the groove 52c and the jaws 30c and 40c are disposed away from each other such that the opening has a second size which is greater than the first size.

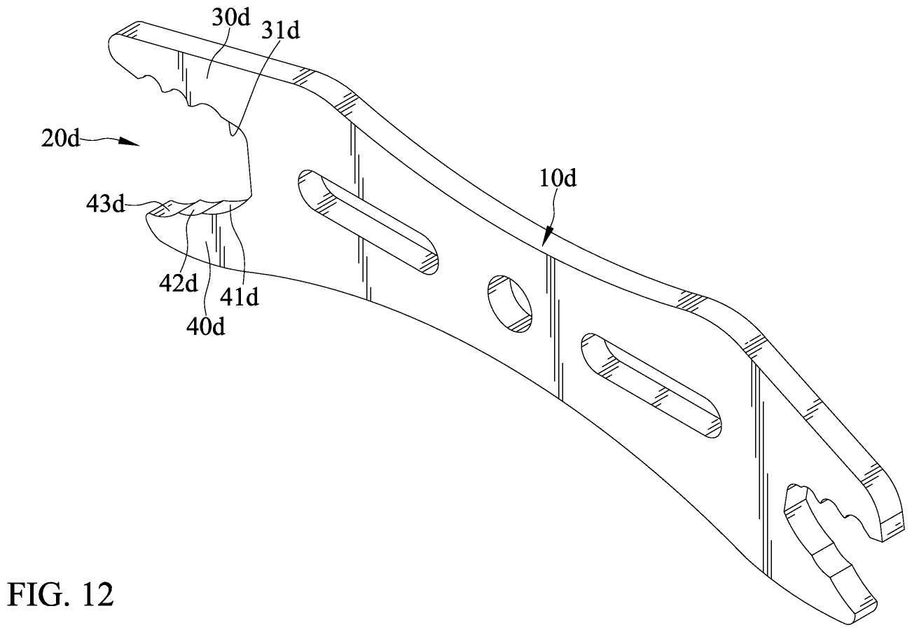

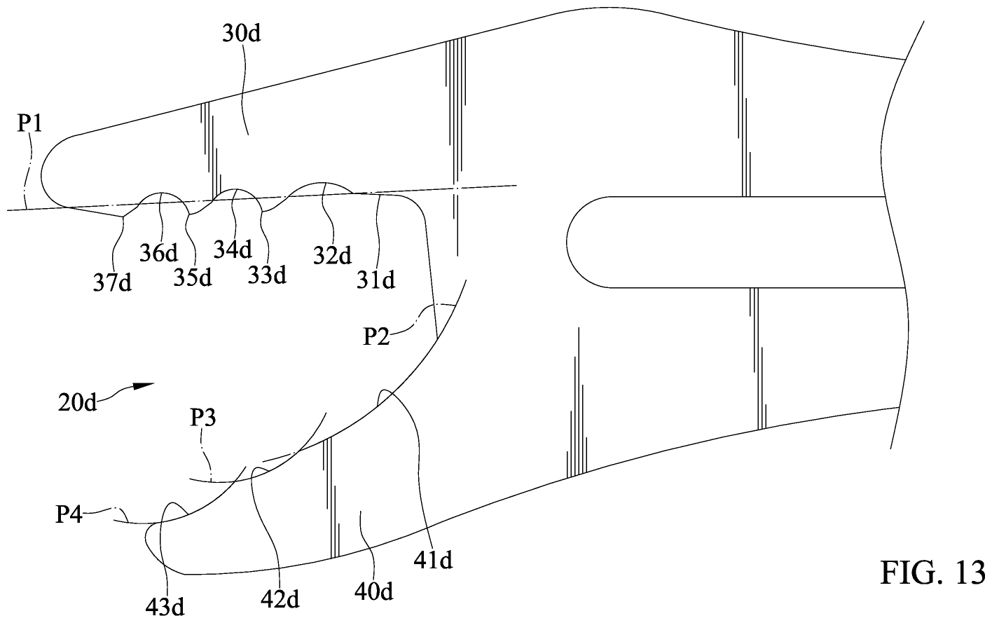

FIGS. 12 and 13 show a tool adapted to be driven rapidly in accordance with a fifth embodiment of the present invention, and the same numbers are used to correlate similar components of the first embodiment, but bearing a letter d. The tool 10d has an opening 20d, a jaw 30d, and a jaw 40d. An engaging side 31d of the jaw 30 extends linearly. An engaging side 41d of the jaw 40d extends curvedly and along a parabola. The tool 10d differentiates from the tool 10 in that the jaw 30d further includes protrusions 33d, 35d, and 37d extending therefrom and a jaw 40d further includes concavities 42d and 43d. The protrusions 33d, 35d, and 37d have bases extending along a linear line P1. The protrusions 33d, 35d, and 37d are disposed successively along the linear line P1. The protrusion 33d is disposed adjacent to the engaging side 31d, which is disposed adjacent to the closed end of the opening 20d. The protrusion 37d is disposed adjacent to the open end of the opening 20d. The engaging side 31d and the protrusion 33d are separated by a recess 32d. The protrusions 33d and 35d are separated by a recess 34d. The protrusions 35d and 37d are separated by a recess 36d. The protrusions 33d, 35d, and 37d have the same height. The concavity 42d is disposed between the engaging side 41d and the concavity 43d. The engaging side 41d is disposed adjacent to the closed end of the opening 20d. The concavity 42d extends along a curved line P3. The concavity 43d extends along a curved line P4.

In the embodiment, each of the protrusions 33d, 35d, and 37d has sides configured to abut against the object to be driven, so a user can drive the object with a larger torque.

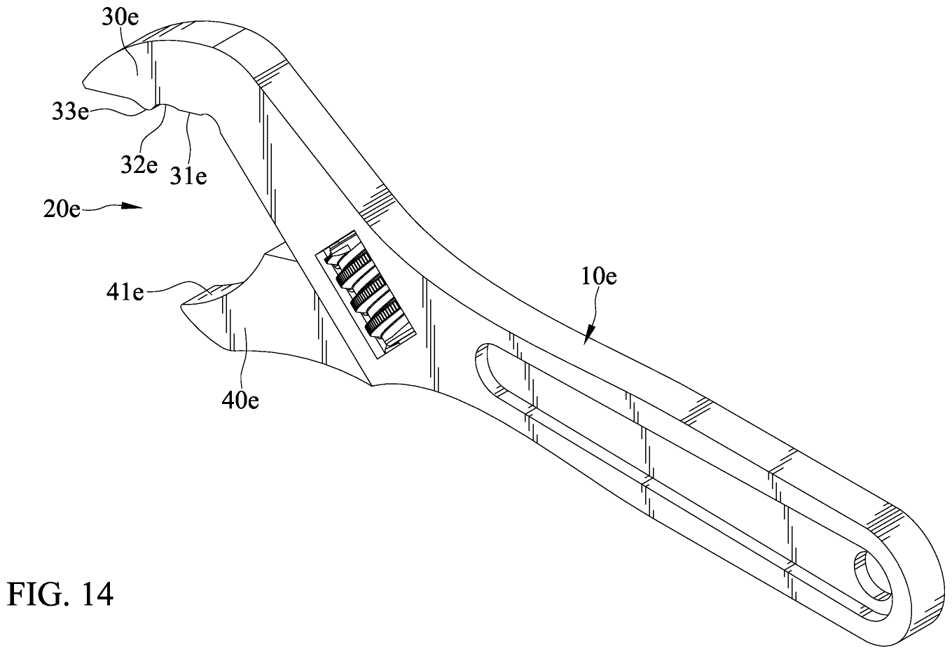

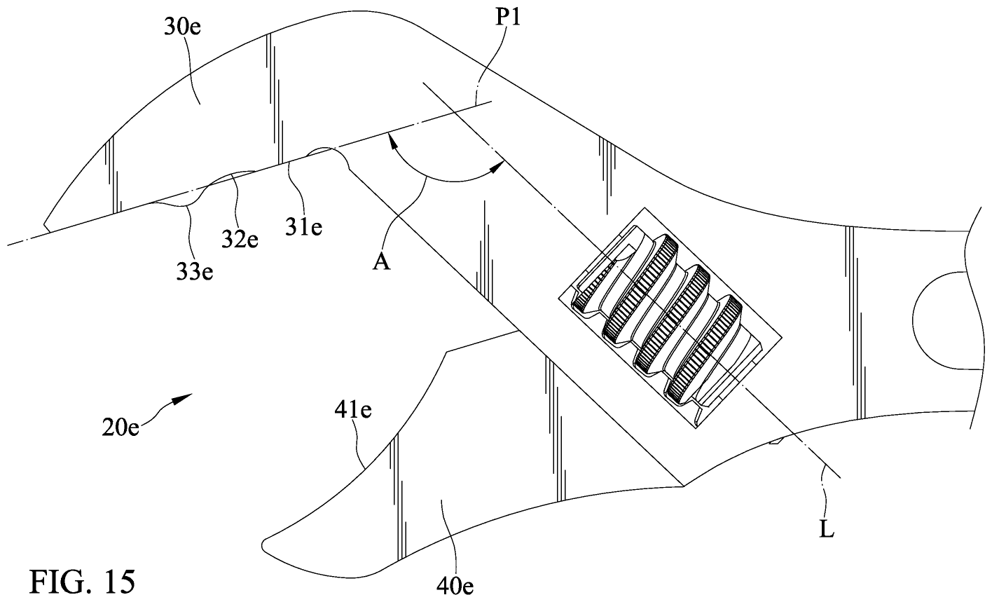

FIGS. 14 and 15 show a tool adapted to be driven rapidly in accordance with a sixth embodiment of the present invention, and the same numbers are used to correlate similar components of the first embodiment, but bearing a letter e. The tool 10e has an opening 20e, a jaw 30e with an engaging side 31e, and a jaw 40e with an engaging side 41e. The engaging side 31d extends linearly. The engaging side 41d extends curvedly and along a parabola. The tool 10e differentiates from the tool 10 in that the jaw 30e further includes a protrusion 33e extending therefrom and a recess 32e and the jaw 40e is operably movable with respect to the jaw 30e. The protrusion 33e has a base extending along a linear line P1. The recess 32e is disposed between the protrusion 33d and the engaging side 31d, which is disposed adjacent to the closed end of the opening 20d. In the embodiment, the protrusion 33d has a side configured to abut against the object to be driven, so a user can drive the object with a larger torque.

In view of the forgoing, the tools 10, 10a, 10b, 10c, 10d, and 10e, which is adapted to be driven rapidly, include the engaging sides 31, 31a, and 31b extending along a linear line P1, the engaging sides 41 and 41e extending along a curved line P2, and the closed ends of the openings 20, 20d, and 20e having a width smaller than a width of the open ends of the opening 20, 20d, and 20e.

The foregoing is merely illustrative of the principles of this invention and various modifications can be made by those skilled in the art without departing from the scope and spirit of the invention.

What is claimed is:

1. A tool adapted to be driven rapidly comprising:
a driving portion having a first jaw and a second jaw configured to hold an object to be driven therebetween and an opening between the first and the second jaws configured to receive the object to be driven, wherein the first and the second jaws 30, 30a, 30b, 30c, 30d, 30e, 40, 40a, 40b, 40c, 40d, 40e) have first and second engaging sides configured to grip the object to be driven, wherein the opening has a closed end, an open end, and two opposite sides respectively delimited by the first and the second engaging sides, wherein the first engaging side extends along a linear line, wherein the second engaging side extends along a curved line, and wherein the closed end of the opening has a width smaller than a width of the open end of the opening.

2. The tool as claimed in claim 1, wherein each of the first and the second engaging sides has a first end adjacent to the closed end of the opening and a second end adjacent to the open end of the opening, and wherein the first ends of the first and the second engaging sides are spaced at a first perpendicular distance measuring a first width, wherein the second ends of the first and the second engaging sides are spaced at a perpendicular distance measuring a second width, and wherein the first width is smaller than the second width.

3. The tool as claimed in claim 1, wherein the second engaging side extends along a parabola.

4. The tool as claimed in claim 3, wherein the parabola has an equation: y²=−12x, wherein the parabola has an axis of symmetry which is perpendicular to the first engaging side, and wherein the parabola has a vertex on an arbitrary axis which is parallel to the first engaging side.

5. The tool as claimed in claim 1, wherein the driving portion has a first body and a second body movably coupled to the first body, wherein the first body has a jaw forming the first jaw, and wherein the second body has a jaw forming the second jaw.

6. The tool as claimed in claim 5, wherein the second body is slidably coupled to the first body such that the opening varies in size in response to sliding movement of the second body with respect to the first body.

7. The tool as claimed in claim 5, wherein the second body is pivotally coupled to the first body such that the opening varies in size in response to pivoting movement of the second body with respect to the first body.

8. The tool as claimed in claim 6, wherein the first body defines a groove and the second body has a connecting portion movably engaged in the groove, wherein the second body is operably movable between a first position in which the connecting portion is disposed adjacent to a first end of the groove and the first and the second jaws are disposed adjacent to each other such that the opening has a first size, and a second position in which the connecting portion is disposed adjacent to a second end of the groove and the first and the second jaws are disposed away from each other such that the opening has a second size which is greater than the first size.

9. The tool as claimed in claim 7, wherein the first body defines a groove and the second body has a connecting portion movably engaged in the groove, wherein the second body is operably movable between a first position in which the connecting portion is disposed adjacent to a first end of the groove and the first and the second jaws are disposed adjacent to each other such that the opening has a first size, and a second position in which the connecting portion is disposed adjacent to a second end of the groove and the first and the second jaws are disposed away from each other such that the opening has a second size which is greater than the first size.

10. The tool as claimed in claim 1, wherein the first and the second engaging sides are formed in one piece.

11. The tool as claimed in claim 6, wherein the first body has a position retaining portion and the second body includes a catch coupled thereto movably engaged with the position retaining portion, and wherein the catch is operably movable between a first position engaging with the position retaining portion such that the second body is unmovably fixed to the first body, and a second position disengaging form the position retaining portion such that the second body is movably disposed on the first body.

12. The tool as claimed in claim 11, wherein the position retaining portion includes a plurality of teeth on which the catch is adapted to engage.

13. The tool as claimed in claim 1, wherein the first jaw includes at least one protrusion extending therefrom, and wherein the protrusion has a base extending along the linear line.

14. The tool as claimed in claim 13, wherein the first jaw includes at least one recess, and wherein the recess is disposed between the at least one protrusion and the engaging side.

15. The tool as claimed in claim 1, wherein the first jaw includes protrusions extending therefrom, wherein the second jaw includes concavities, wherein the protrusions have bases extending along the linear line P1, wherein the protrusions are disposed successively along the linear line, wherein one of the protrusions is disposed adjacent to the closed end of the opening, wherein one of the protrusions is disposed adjacent to the open end of the opening.

16. The tool as claimed in claim 15, wherein the first engaging side and the protrusion adjacent thereto include a recess disposed therebetween, and wherein two adjacent protrusion includes a recess disposed therebetween.

17. The tool as claimed in claim 16, wherein the protrusions have the same height.
